(19) United States
(12) Patent Application Publication
(10) Pub. No.: US 2023/0400291 A1
(43) Pub. Date: Dec. 14, 2023

(54) DETECTING WEAR OF TRACK LINK PIN BASED ON SENSOR DATA OF A SENSOR DEVICE PROVIDED IN A CAVITY OF THE TRACK LINK PIN

(71) Applicant: Caterpillar Inc., Peoria, IL (US)

(72) Inventors: Michael Stephen GALAT, Peoria, IL (US); Temitope O. AKINLUA, Peoria, IL (US)

(73) Assignee: Caterpillar Inc., Peoria, IL (US)

(21) Appl. No.: 17/806,560

(22) Filed: Jun. 13, 2022

(51) Int. Cl. G01B 7/02

(52) U.S. Cl. CPC G01B 7/02

(57) ABSTRACT

In some implementations, one or more devices may determine an electrical property of a wear measuring component of a sensor device, the sensor device being provided in a first cavity of a track link pin of a track assembly of the machine, the wear measuring component extending from the first cavity through a second cavity of the track link pin to an outer surface of the track link pin. The one or more devices may determine a length of the wear measuring component based on the electrical property. The one or more devices may generate sensor data indicating an amount of wear of the outer surface based on the length of the wear measuring component. The one or more devices may provide the sensor data to a controller of the machine to cause the controller to provide a notification regarding the amount of wear of the outer surface.

### TECHNICAL FIELD

The present disclosure relates generally to determining wear of a track link pin and, for example, to determining wear of the track link pin based on sensor data of a sensor device provided in a cavity of the track link pin.

### BACKGROUND

Components of a track assembly of a machine may wear over a period of time. For example, a track link pin of the track assembly may wear over a period of time. Typically, the track link pin is provided in a cavity of another component of the track assembly, such as a cavity of a track link bushing of a track link. As result of the track link pin being provided in the cavity, an outer surface of the track link pin may wear due to the friction between the track link pin and the cavity during various operations of the machine over time. The wear of the outer surface may be referred to as an internal wear because the wear is occurring internally with respect to the cavity.

Because the track link pin is provided in the cavity, measuring an amount of wear of the outer surface of the track link pin is a difficult task. In the event that a measurement of the amount of wear of the outer surface is obtained, such measurement is a manual measurement and is typically inaccurate.

Due to the inability to measure the amount of wear of the outer surface and/or the inaccuracy of the measurement of the amount of wear of the outer surface, the machine may be operated when the track link pin has been worn to an amount that would require a replacement of the track link pin. Operating the machine this manner may cause damage to the track link pin (or cause catastrophic failure of the track link pin), may cause damage to other components of the track assembly, and eventually may cause damage to the machine.

International Patent Application Publication No. WO2021240288 (the '288 publication) discloses a track pin assembly comprising a pin comprising a first axial end and a second axial end configured to engage a respective outer link of a joint. The '288 publication further discloses that the pin includes a first cavity which defines a tank for containing lubricating oil or grease. The '288 publication further discloses that the pin includes a second cavity arranged at the second axial end of the pin and open at the second axial end of the pin.

The '288 publication additionally discloses that the pin includes a sensor arranged in the second cavity and comprising a sensor element configured to measure a temperature and to generate a signal indicative of the measured temperature. While the '288 publication discloses that the pin includes the sensor arranged in the second cavity, the '288 publication does not address detecting wear of the pin.

The system of the present disclosure solves one or more of the problems set forth above and/or other problems in the art.

### SUMMARY

In some implementations, a system includes a track link pin of a track assembly of a machine, the track link pin including a first cavity and a second cavity extending from the first cavity to an outer surface of the track link pin; a sensor device configured to be provided in the first cavity of the track link pin, the sensor device being configured to: determine an electrical property of a wear measuring component of the sensor device, the wear measuring component extending from the first cavity through the second cavity to the outer surface; determine a length of the wear measuring component based on the electrical property, and generate sensor data indicating an amount of wear of the outer surface based on the length of the wear measuring component; and a controller configured to cause the machine to perform an action based on the sensor data.

In some implementations, a method performed by one or more devices of a machine includes determining, by a sensor device of the machine, an electrical property of a wear measuring component of the sensor device, the sensor device being provided in a first cavity of a track link pin of a track assembly of the machine, the wear measuring component extending from the first cavity through a second cavity of the track link pin to an outer surface of the track link pin; determining, by the sensor device, a length of the wear measuring component based on the electrical property; generating, by the sensor device, sensor data indicating an amount of wear of the outer surface based on the length of the wear measuring component; and providing, by the sensor device, the sensor data to a controller of the machine to cause the controller to provide a notification regarding the amount of wear of the outer surface.

In some implementations, a machine comprises: a track assembly that includes a component having a first cavity and a second cavity extending from the first cavity to an outer surface of the component; and a sensor device configured to be provided in the first cavity of the component, the sensor device being configured to: determine an electrical property of a wear measuring component of the sensor device, the wear measuring component extending from the first cavity through the second cavity to the outer surface; determine a length of the wear measuring component based on the electrical property, and generate sensor data indicating an amount of wear of the outer surface based on the length of the wear measuring component; and a controller configured to provide a notification based on the amount of wear of the outer surface indicated by the sensor data.

### BRIEF DESCRIPTION OF THE DRAWINGS

FIG. 1 is a diagram of an example machine described herein.

FIG. 2 is a diagram of a cross-sectional view of an example track link pin described herein.

FIG. 3 is a diagram of an example system described herein.

FIG. 4 is a flowchart of an example process relating to determining wear of a track link pin.

### DETAILED DESCRIPTION

Implementations described herein are directed to determining an amount of wear of an outer surface of a track link pin and providing a notification indicating the amount of wear of the outer surface. For example, a system described herein may include a sensor device provided in a first cavity of the track link pin. The sensor device may include a wear measuring component provided in a second cavity of the track link pin. The wear measuring component may extend through the second cavity to the outer surface of the track link pin. The sensor device may determine an electrical property of the wear measuring component. Based on the electrical property, the sensor device may determine a length of the wear measuring component. The wear measuring component may be provided in the second cavity in a manner that causes the length of the wear measuring component to decrease as the outer surface of the track link pin wears away.

Based on the length of the wear measuring component, the sensor device may generate sensor data indicating the amount of wear of the outer surface of the track link pin. In some instances, the amount of wear of the outer surface may be proportional to the length of the wear measuring component. Alternatively, the amount of wear of the outer surface may be determined based on one or more mathematical operations involving the length of the wear measuring component.

A controller may receive the sensor data (e.g., via a wireless communication component of the machine) and may cause the machine to perform an action based on the sensor data. For example, the controller may provide a notification indicating the amount of wear of the outer surface, may provide a recommendation to replace the track link pin, may provide a command to derate an engine of the machine, among other examples.

The term “machine” may refer to a device that performs an operation associated with an industry such as, for example, mining, construction, farming, transportation, or another industry. Moreover, one or more implements may be connected to the machine. As an example, a machine may include a construction vehicle, a work vehicle, or a similar vehicle associated with the industries described above.

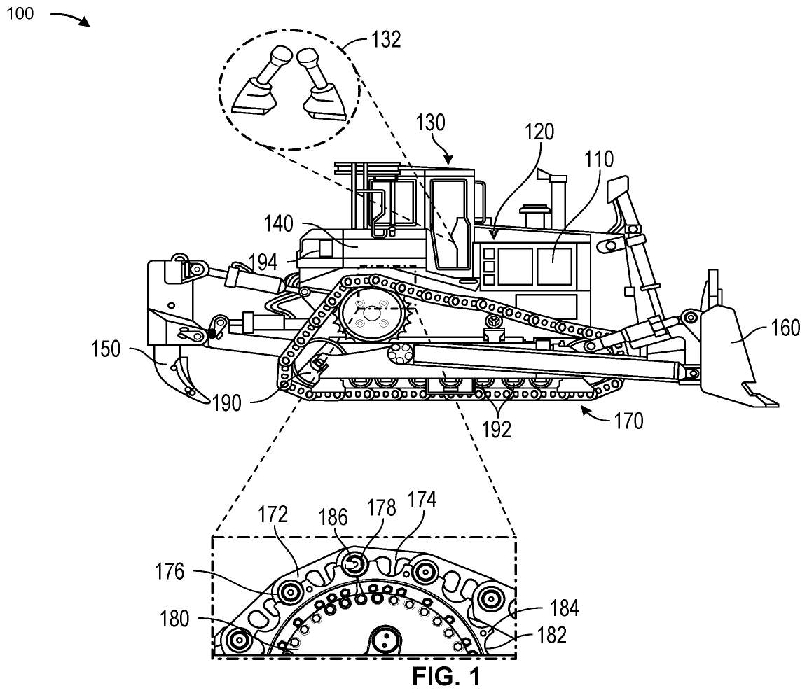

FIG. 1 is a diagram of an example machine 100 described herein. As shown in FIG. 1, machine 100 is embodied as an earth moving machine, such as a dozer. Alternatively, machine 100 may be another type of track-type machine such as an excavator.

As shown in FIG. 1, machine 100 includes an engine 110, a sensor system 120, an operator cabin 130, operator controls 132, a controller 140, a rear attachment 150, a front attachment 160, ground engaging members 170, sprocket 180, one or more sensor devices 186, one or more idlers 190, one or more rollers 192, and a wireless communication component 194.

Engine 110 may include an internal combustion engine, such as a compression ignition engine, a spark ignition engine, a laser ignition engine, a plasma ignition engine, and/or the like. Engine 110 provides power to machine 100 and/or a set of loads (e.g., components that absorb power and/or use power to operate) associated with machine 100. For example, engine 110 may provide power to one or more control systems (e.g., controller 140), sensor system 120, operator cabin 130, and/or ground engaging members 170.

Engine 110 can provide power to an implement of machine 100, such as an implement used in mining, construction, farming, transportation, or any other industry. For example, engine 110 may power components (e.g., one or more hydraulic pumps, one or more actuators, and/or one or more electric motors) to facilitate control of rear attachment 150 and/or front attachment 160 of machine 100.

Sensor system 120 may include sensor devices that are capable of generating signals regarding an operation of machine 100. The sensor devices, of sensor system 120, may include a load sensor device, a velocity sensor device, a torque sensor device, a vibration sensor device, a motion sensor device, among other examples. As an example, the sensor devices may include one or more inertial measurement units (IMUs).

Operator cabin 130 includes an integrated display (not shown) and operator controls 132. Operator controls 132 may include one or more input components (e.g., integrated joysticks, push-buttons, control levers, and/or steering wheels) to control an operation of machine 100. For example, operator controls 132 may be used to control an operation of one or more implements of machine 100 (e.g., rear attachment 150 and/or front attachment 160) and/or control an operation of ground engaging members 170.

For an autonomous machine, operator controls 132 may not be designed for use by an operator and, rather, may be designed to operate independently from an operator. In this case, for example, operator controls 132 may include one or more input components that provide an input signal for use by another component without any operator input.

Controller 140 (e.g., an electronic control module (ECM)) may control and/or monitor operations of machine 100. For example, controller 140 may control and/or monitor the operations of machine 100 based on signals from operator controls 132 and/or from sensor system 120. In some instances, controller 140 may determine an amount of wear of one or more components of machine 100 based on the signals from one or more sensor devices 186, as described in more detail below.

Rear attachment 150 may include a ripper assembly, a winch assembly, and/or a drawbar assembly. Front attachment 160 may include a blade assembly. Ground engaging members 170 may be configured to propel machine 100. Ground engaging members 170 may include wheels, tracks, rollers, and/or similar components, for propelling machine 100. Ground engaging members 170 may include a track assembly that includes tracks (as shown in FIG. 1). The tracks may include track links. In some situations, track link may include a track link bushing and a track link pin. As an example, the tracks may include a first track link 172 and a second track link 174. First track link 172 includes a first track link bushing 176 and a first track link pin 178.

Sprocket 180 may include one or more sprocket segments 182 (referred to herein individually as “sprocket segment 182,” and collectively as “sprocket segments 182”). Sprocket 180 may be configured to engage with ground engaging members 170 and to drive ground engaging members 170. For example, sprocket segments 182 may be configured to engage track link bushings (e.g., of the tracks of ground engaging members 170) and rotate to cause the tracks to propel machine 100. As shown in FIG. 1, sprocket segment 182 may include a tip 184. Sprocket 180 may be included in a drivetrain of machine 100.

In some situations, first track link pin 178 may experience wear. For example, an outer surface of first track link pin 178 may experience wear. As the outer surface experiences wear, a diameter of first track link pin 178 may decrease. A sensor device 186 may be configured to determine an amount of wear of the outer surface of first track link pin 178. For example, sensor device 186 may include one or more devices configured to determine a length of a wear measuring component of sensor device 186 and may generate sensor data indicating the amount of wear of the outer surface based on the length of the wear measuring component. The sensor data may further include information identifying sensor device 186.

As described in more detail below, sensor device 186 may be provided in a cavity of first track link pin 178, another sensor device 186 may be provided in a cavity of another track link pin of the track assembly, and so on. In some situations, the sensor data may be provided (e.g., via wireless communication component 194) to controller 140. Controller 140 may control an operation of machine 100 based on the amount of wear of the outer surface of first track link pin 178, as described in more detail below.

In some examples, one or more idlers 190 and/or one or more rollers 192 may guide the tracks as the tracks rotate to propel machine 100. In some examples, ground engaging members 170, sprocket 180, one or more idlers 190, and one or more rollers 192 may be components of the track assembly. The track assembly may further include one or more track pads and/or one or more track shoes.

Wireless communication component 194 may include one or more devices that are capable of communicating with one or more components of machine 100, one or more other machines, and/or one or more devices, as described herein. For example, wireless communication component 194 may receive the sensor data from sensor device 186 and may provide the sensor data to controller 140, to the one or more other machines, and/or to the one or more devices.

Wireless communication component 194 may include a transceiver, a separate transmitter and receiver, and/or an antenna, among other examples. Wireless communication component 194 may communicate with the one or more machines using a short-range wireless communication protocol such as, for example, BLUETOOTH® Low-Energy, BLUETOOTH®, Wi-Fi, near-field communication (NFC), Z-Wave, ZigBee, or Institute of Electrical and Electronics Engineers (IEEE) 802.154, among other examples. Additionally, or alternatively, wireless communication component 194 may communicate with the one or more other machines and/or the one or more devices via a network that includes one or more wired and/or wireless networks.

As indicated above, FIG. 1 is provided as an example. Other examples may differ from what is described in connection with FIG. 1.

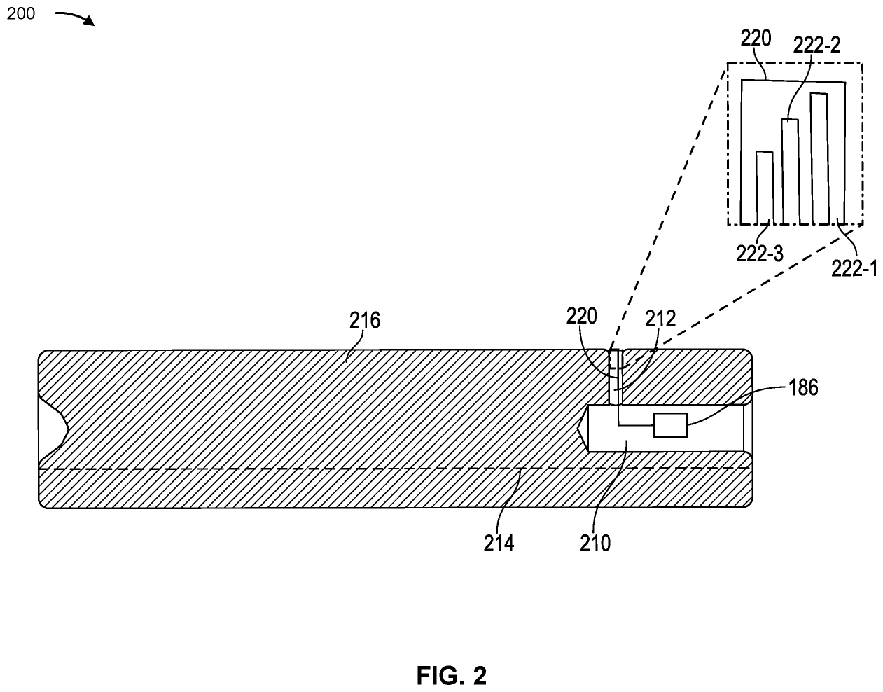

FIG. 2 is a diagram of a cross-sectional view of an example track link pin 200 described herein. Track link pin 200 may correspond to first track link pin 178. As shown in FIG. 2, track link pin 200 may include a first cavity 210 and a second cavity 212. First cavity 210 may be parallel to a longitudinal axis 214 of track link pin 200. As shown in FIG. 2, second cavity 212 may extend from first cavity 210 to an outer surface 216 of track link pin 200.

In some instances, second cavity 212 may be provided at an angle with respect to first cavity 210. For example, second cavity 212 may be perpendicular to first cavity 210. Second cavity 212 may be provided parallel to a radial axis of track link pin 200.

As shown in FIG. 2, track link pin 200 may include sensor device 186. Unlike track link pin 200, typical track link pins may be provided without first cavity 210 and second cavity 212. Track link pin 200 may be provided with first cavity 210 and second cavity 212 to enable track link pin 200 to receive sensor device 186. As shown in FIG. 2, sensor device 186 may be provided in first cavity 210. In some implementations, sensor device 186 may be a battery powered signal transmitter (or battery powered transmitter). For example, sensor device 186 may include a power source (e.g., a battery) to provide power to sensor device 186 and a communication component (similar to wireless communication component 194) to transmit sensor data generated by sensor device 186.

As shown in FIG. 2, sensor device 186 may include a wear measuring component 220. Wear measuring component 220 may extend from first cavity 210 through second cavity 212 to outer surface 216 of track link pin 200. Sensor device 186 may be configured to determine a length of wear measuring component 220 and generate the sensor data indicating an amount of wear of outer surface 216 based on the length of wear measuring component 220. The length of wear measuring component 220 may indicate the amount of wear of outer surface 216. For example, as outer surface 216 experiences wear and a portion of outer surface 216 wears away, the length of wear measuring component 220 may decrease accordingly.

The length of wear measuring component 220 may decrease because wear measuring component 220 may be provided in second cavity 212 in a manner that causes wear measuring component 220 to wear away as outer surface 216 wears away. As an example, a first length of wear measuring component 220 may correspond to a first amount of wear of outer surface 216, a second length of wear measuring component 220 may correspond to a second amount of wear of outer surface 216, and so on. The first length may exceed the second length. Accordingly, the second amount of wear may exceed the first amount of wear.

In some situations, sensor device 186 may determine the length of wear measuring component 220 based on determining an electrical property of wear measuring component 220. For example, sensor device 186 may determine an electrical resistance of wear measuring component 220 and determine the length of wear measuring component 220 based on the electrical resistance of wear measuring component 220. In this regard, as the length of wear measuring component 220 decreases, the electrical resistance of wear measuring component 220 decreases accordingly. For instance, the first length of wear measuring component 220 may have a first electrical resistance, the second length of wear measuring component 220 may have a second electrical resistance, and so on. The first length may exceed the second length. The first electrical resistance may exceed the second electrical resistance.

In some situations, the length of wear measuring component 220 (prior to wear measuring component 220 experiencing any amount of wear) may depend on a type of machine 100. Additionally, or alternatively, the length of wear measuring component 220 (prior to wear measuring component 220 experiencing any amount of wear) may depend on a size of track link pin 200. As an example, the length of wear measuring component 220 for a machine of a first type may indicate that track link pin 200 is to be replaced, while the same length of wear measuring component 220 for a machine of a second type may indicate that track link pin 200 is not to be replaced.

As shown in FIG. 2, wear measuring component 220 may include multiple closed loop electrical circuits 222 (individually “closed loop electrical circuit 222” and collectively “closed loop electrical circuits 222”). For example, wear measuring component 220 may include a closed loop electrical circuit 222-1, a closed loop electrical circuit 222-2, a closed loop electrical circuit 222-3, and so on. In some instances, sensor device 186 may determine the length of wear measuring component 220 based on closed loop electrical circuits 222. Each closed loop electrical circuit 222 may be associated with a respective length of wear measuring component 220. For example, closed loop electrical circuit 222-1 may be associated with the first length of wear measuring component 220, closed loop electrical circuit 222-2 may be associated with the second length of wear measuring component 220, closed loop electrical circuit 222-3 may be associated with a third length of wear measuring component 220, and so on. The first length may exceed the second length and the third length. The second length may exceed the third length.

Sensor device 186 may determine the length of wear measuring component 220 based on electric properties of closed loop electrical circuits 222. For example, sensor device 186 may determine the first length of sensor device 186 based on determining a first electrical resistance of closed loop electrical circuit 222-1, may determine the second length of sensor device 186 based on determining a second electrical resistance of closed loop electrical circuit 222-2, and so on.

As explained above, wear measuring component 220 may be provided in second cavity 212 such that wear measuring component 220 wears away as outer surface 216 wears away. In this regard, as outer surface 216 wears away, closed loop electrical circuit 222-1 may become open (or broken), followed by closed loop electrical circuit 222-2 becoming open, and so on. As a result of closed loop electrical circuit 222-1 becoming open (or broken), the first electrical resistance of closed loop electrical circuit 222-1 may not satisfy a resistance threshold. Based on determining that the first electrical resistance of closed loop electrical circuit 222-1 does not satisfy the resistance threshold, sensor device 186 may determine that closed loop electrical circuit 222-1 is open. Accordingly, sensor device 186 may determine that wear measuring component 220 has been worn away to a length that is less than the first length.

After determining that closed loop electrical circuit 222-1 is open, sensor device 186 may determine whether the second electrical resistance of closed loop electrical circuit 222-2 satisfies the resistance threshold. Based on determining that second electrical resistance satisfies the resistance threshold, sensor device 186 may determine that the length of sensor device 186 is the second length. Alternatively, based on determining that second electrical resistance does not satisfy the resistance threshold, sensor device 186 may determine whether the third electrical resistance of closed loop electrical circuit 222-3 satisfies the resistance threshold, and so on.

As explained above, sensor device 186 may generate the sensor data indicating the amount of wear of outer surface 216 based on the length of wear measuring component 220. For example, sensor device 186 may generate the sensor data indicating the first amount of wear of outer surface 216 based on determining that the length of wear measuring component 220 is the first length of wear measuring component 220, may generate the sensor data indicating the second amount of wear of outer surface 216 based on determining that the length of wear measuring component 220 is the second length of wear measuring component 220, and so on.

Sensor device 186 may provide the sensor data to controller 140 (e.g., via wireless communication component 194). For example, sensor device 186 may provide the sensor data to wireless communication component 194 to cause wireless communication component 194 to provide the sensor data to controller 140.

As indicated above, FIG. 2 is provided as an example. Other examples may differ from what is described in connection with FIG. 2.

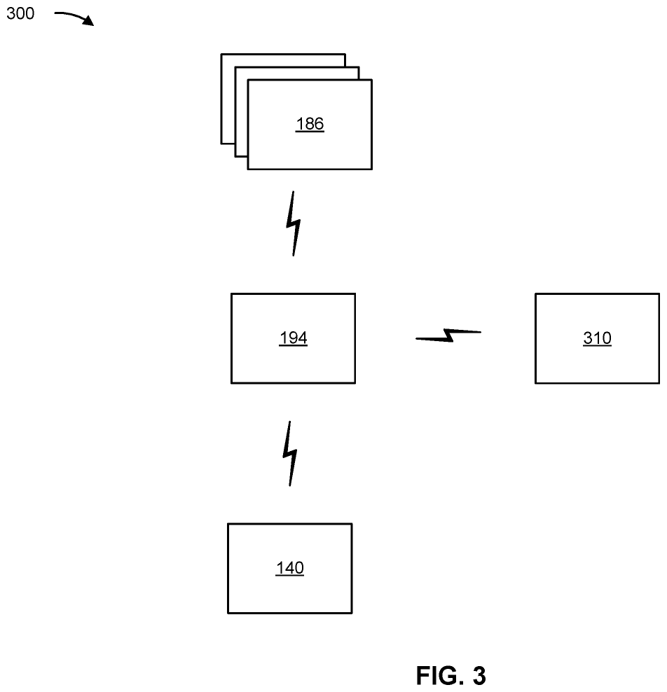

FIG. 3 is a diagram of an example system 300 described herein. As shown in FIG. 3, system 300 includes controller 140, multiple sensor devices 186 (collectively “sensor devices 186” and individually “sensor device 186”), wireless communication component 194, and a device 310 associated with machine 100. Some of the elements of FIG. 3 have been described above in connection with FIGS. 1 and 2.

Controller 140 may include one or more processors and one or more memories. A processor may be implemented in hardware, firmware, and/or a combination of hardware and software. A processor may be capable of being programmed to perform a function. A memory may store information and/or instructions for use by a processor to perform the function. For example, when performing the function, controller 140 may control an operation of machine 100 based on the sensor data provided by sensor devices 186.

In some examples, each sensor device 186 may be included in a respective track link pin of the track assembly of machine. In this regard, sensor information identifying a sensor device 186 may be stored, in a data structure, in association with pin information identifying a track link pin in which the sensor device 186 is configured to be included. The data structure may be a database, a table, and/or a linked list. The sensor information of a sensor device 186 may include a serial number of the sensor device 186, and/or a media access control (MAC) address associated with the sensor device 186, among other examples. The pin information of a track link pin may include a part number of the track link pin, and/or a serial number of the track link pin, among other examples.

Device 310 may include a display included in operator cabin 130. Additionally, or alternatively, device 310 may include a user device of an operator of machine 100, a user device of a site manager associated with machine 100, and/or a user device of an owner of machine 100. Additionally, or alternatively, device 310 may include a back office system (e.g., that monitors an operation of machine 100).

In some examples, controller 140 may receive the sensor data provided by sensor device 186 (e.g., included in track link pin 200). Controller 140 may receive the sensor data from sensor device 186. Alternatively, sensor device 186 may provide the sensor data to wireless communication component 194 and wireless communication component 194 may provide the sensor data to controller 140. In some examples, wireless communication component 194 may provide the sensor data to device 310.

Sensor device 186 may generate the sensor data in a manner similar to the manner described above in connection with FIG. 2. The sensor data may include the sensor information identifying sensor device 186. In some implementations, the sensor data may further include information identifying the length of wear measuring component 220. In this regard, controller 140 may determine the amount of wear of outer surface 216 based on the length of wear measuring component 220.

For example, controller 140 may perform a lookup operation of a data structure that stores information identifying different lengths of sensor device 186 in association with information identifying different amounts of wear of outer surface 216. In some implementations, the sensor data may include information indicating the amount of wear of outer surface 216. Controller 140 may determine the amount of wear based on the information indicating the amount of wear of outer surface 216 (included in the sensor data).

Controller 140 may determine whether the amount of wear satisfies a wear threshold. In some situations, controller 140 may be pre-configured with information identifying the wear threshold. Additionally, or alternatively, machine 100 may receive the information identifying the wear threshold from the user device of the operator, the user device of the site manager, and/or the user device of the owner of machine 100. Additionally, or alternatively, machine 100 may receive the information identifying the wear threshold from the back office system.

In some examples, controller 140 may cause machine 100 to perform the action based on determining that the amount of wear does not satisfy the wear threshold. For example, when causing machine 100 to perform the action, controller 140 may provide a notification based on determining that the amount of wear does not satisfy the wear threshold. The notification may be provided to device 310. The notification may include information indicating that the amount of wear does not satisfy the wear threshold. Additionally, or alternatively, the notification may include a first recommendation to service the track link pin. Additionally, or alternatively, the notification may include a second recommendation to replace the track link pin.

In some situations, when causing machine 100 to perform the action, controller 140 may provide a command to derate engine 110. For example, controller 140 may provide the command to an engine controller associated with engine 110 to cause engine 110 to be derated.

In some examples, controller 140 may cause machine 100 to perform the actions discussed above based on different wear thresholds. For example, controller 140 may provide the first recommendation based on determining that the amount of wear does not satisfy a first wear threshold. Alternatively, controller 140 may provide the second recommendation and/or provide the command to derate engine 110 based on determining that the amount of wear does not satisfy a second wear threshold. The first wear threshold may exceed the second wear threshold.

The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the example component may perform one or more functions described as being performed by another set of devices of the example component.

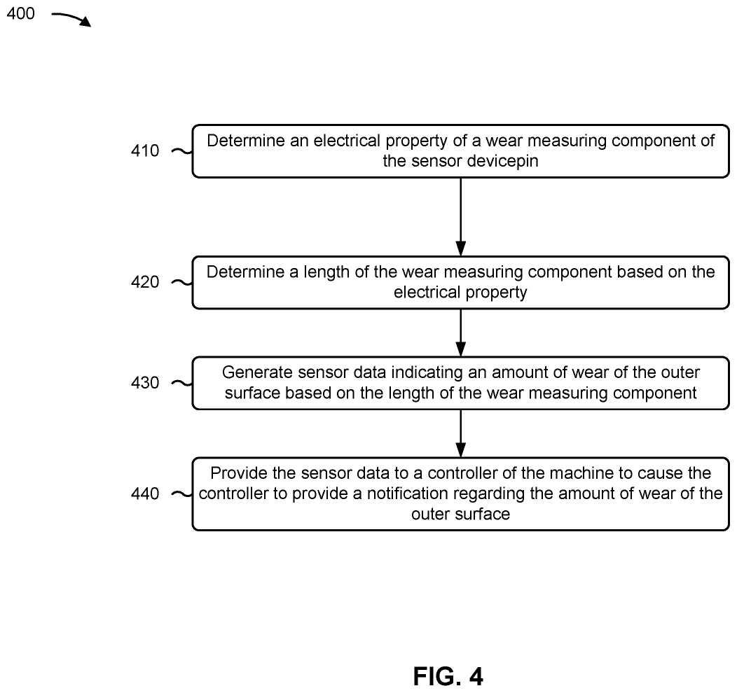

FIG. 4 is a flowchart of an example process 400 associated with track link pin wear detection based on sensor data. In some implementations, one or more process blocks of FIG. 4 may be performed by one or more devices (e.g., controller 140 and/or sensor device 186). In some implementations, one or more process blocks of FIG. 4 may be performed by another device or a group of devices separate from or including the one or more devices, such as a wireless communication component (e.g., wireless communication component 194), and/or a device (e.g., device 310).

As shown in FIG. 4, process 400 may include determining an electrical property of a wear measuring component of the sensor device, the sensor device being provided in a first cavity of a track link pin of a track assembly of the machine, and the wear measuring component extending from the first cavity through a second cavity of the track link pin to an outer surface of the track link pin (block 410). For example, the one or more devices may determine an electrical property of a wear measuring component of the sensor device, the sensor device being provided in a first cavity of a track link pin of a track assembly of the machine, and the wear measuring component extending from the first cavity through a second cavity of the track link pin to an outer surface of the track link pin, as described above.

As further shown in FIG. 4, process 400 may include determining a length of the wear measuring component based on the electrical property (block 420). For example, the one or more devices may determine a length of the wear measuring component based on the electrical property, as described above.

In some implementations, the wear measuring component includes a first closed loop electrical circuit associated with a first length of the wear measuring component and a second closed loop electrical circuit associated with a second length of the wear measuring component, and determining the length of the wear measuring component comprises determining a first electrical resistance of the first closed loop electrical circuit, determining that the first electrical resistance does not satisfy a resistance threshold, and determining that the length of the wear measuring component is the second length based on determining that the first electrical resistance does not satisfy the resistance threshold.

In some implementations, determining the length of the wear measuring component comprises determining a second electrical resistance of the second closed loop electrical circuit, determining that the second electrical resistance does not satisfy the resistance threshold, and determining that the length of the wear measuring component is a third length based on determining that the second electrical resistance does not satisfy the resistance threshold, after determining that the length of the wear measuring component is the first length. The first length exceeds the second length and the third length. The second length exceeds the third length.

As further shown in FIG. 4, process 400 may include generating sensor data indicating an amount of wear of the outer surface based on the length of the wear measuring component (block 430). For example, the one or more devices may generate sensor data indicating an amount of wear of the outer surface based on the length of the wear measuring component, as described above.

As further shown in FIG. 4, process 400 may include providing the sensor data to a controller of the machine to cause the controller to provide a notification regarding the amount of wear of the outer surface (block 440). For example, the one or more devices may provide the sensor data to a controller of the machine to cause the controller to provide a notification regarding the amount of wear of the outer surface, as described above.

In some implementations, process 400 includes determining, by the controller, whether the amount of wear of the outer surface satisfies a wear threshold, and providing, by the controller, the notification based on determining that the amount of wear of the outer surface does not satisfy the wear threshold.

In some implementations, determining the electrical property of the wear measuring component comprises determining an electrical resistance of the wear measuring component, and determining the length of the wear measuring component comprises determining the length of the wear measuring component based on the electrical resistance.

### INDUSTRIAL APPLICABILITY

Implementations described herein are directed to determining an amount of wear of an outer surface of a track link pin of a track assembly of a machine. Additionally, implementations described herein are directed to providing a notification indicating the amount of wear of the outer surface.

Currently, because the track link pin is provided in the cavity, measuring an amount of wear of the outer surface of the track link pin is a difficult task. Additionally, in the event that a measurement of the amount of wear of the outer surface is obtained, such measurement is a manual measurement and is typically inaccurate. As a result of the inability to measure the amount of wear of the outer surface and/or the inaccuracy of the measurement of the amount of wear of the outer surface, the machine may be operated in a manner that may cause damage to the track link pin (or cause catastrophic failure to the track link pin), may cause damage to other components of the track assembly, and eventually may cause damage to the machine.

Implementations described herein are directed to a system that may include a sensor device provided in a first cavity of the track link pin. The sensor device may include a wear measuring component that is provided in a second cavity of the track link pin and that extends through the second cavity to the outer surface of the track link pin. The sensor device may determine an electrical property of the wear measuring component and, based on the electrical property, may determine a length of the wear measuring component. The length of the wear measuring component may correlate with the amount of the wear of the outer surface. As a result, the amount of wear of the outer surface may be more accurately determined.

Determining the amount of wear of the outer surface more accurately provides some advantages. For example, by determining the amount of wear of the outer surface more accurately, the system described herein may enable a proper operation of the machine. Accordingly, by determining the amount of wear of the outer surface more accurately, the system described herein may prevent damage to the track link pin, may prevent damage to other components of the track assembly, and may prevent damage to the machine.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A system, comprising:
a track link pin of a track assembly of a machine, the track link pin including a first cavity and a second cavity extending from the first cavity to an outer surface of the track link pin;
a sensor device configured to be provided in the first cavity of the track link pin, the sensor device being configured to:
determine an electrical property of a wear measuring component of the sensor device,
the wear measuring component extending from the first cavity through the second cavity to the outer surface;
determine a length of the wear measuring component based on the electrical property, and
generate sensor data indicating an amount of wear of the outer surface based on the length of the wear measuring component; and
a controller configured to cause the machine to perform an action based on the sensor data.

2. The system of claim 1, wherein, to cause the machine to perform the action, the controller is configured to:
determine whether the amount of wear, indicated by the sensor data, satisfies a wear threshold; and
cause the machine to perform the action based on determining that the amount of wear does not satisfy the wear threshold.

3. The system of claim 2, wherein, to cause the machine to perform the action, the controller is configured to:
determine that the amount of wear, indicated by the sensor data, does not satisfy the wear threshold; and
provide a notification based on determining that the amount of wear does not satisfy the wear threshold.

4. The system of claim 1, wherein, to determine the electrical property, the sensor device is configured to:
determine an electrical resistance of the wear measuring component; and
wherein, to determine the length of the wear measuring component, the sensor device is configured to:
determine the length of the wear measuring component based on the electrical resistance.

5. The system of claim 1, wherein the wear measuring component includes a plurality of closed loop electrical circuits,
wherein each closed loop electrical circuit, of the plurality of closed loop electrical circuits, is associated with a respective length of the wear measuring component, and
wherein, to determine the length of the wear measuring component, the controller is configured to:
determine one or more electrical properties of one or more closed loop electrical circuits of the plurality of closed loop electrical circuits; and
determine the length of the wear measuring component based on the electrical property of the one or more closed loop electrical circuits.

6. The system of claim 5, wherein, to determine the length of the wear measuring component, the sensor device is configured to:
determine a first length of the wear measuring component based on determining a first electrical property of a first closed loop electrical circuit of the one or more closed loop electrical circuits, and
determine a second length of the wear measuring component based on determining a second electrical property of a second closed loop electrical circuit of the one or more closed loop electrical circuits.

7. The system of claim 1, wherein the track link pin is provided in a cavity of a track link bushing,
wherein the first cavity is parallel to a longitudinal axis of the track link pin, and
wherein the second cavity is perpendicular to the first cavity.

8. The system of claim 1, wherein the sensor device is a battery powered signal transmitter.

9. A method performed by one or more devices of a machine, the method comprising:
determining, by a sensor device of the machine, an electrical property of a wear measuring component of the sensor device,
the sensor device being provided in a first cavity of a track link pin of a track assembly of the machine,
the wear measuring component extending from the first cavity through a second cavity of the track link pin to an outer surface of the track link pin;
determining, by the sensor device, a length of the wear measuring component based on the electrical property;
generating, by the sensor device, sensor data indicating an amount of wear of the outer surface based on the length of the wear measuring component; and
providing, by the sensor device, the sensor data to a controller of the machine to cause the controller to provide a notification regarding the amount of wear of the outer surface.

10. The method of claim 9, further comprising:
determining, by the controller, whether the amount of wear of the outer surface satisfies a wear threshold; and
providing, by the controller, the notification based on determining that the amount of wear of the outer surface does not satisfy the wear threshold.

11. The method of claim 9, wherein determining the electrical property of the wear measuring component comprises:
determining an electrical resistance of the wear measuring component; and
wherein determining the length of the wear measuring component comprises:
determining the length of the wear measuring component based on the electrical resistance.

12. The method of claim 9, wherein the wear measuring component includes a first closed loop electrical circuit associated with a first length of the wear measuring component and a second closed loop electrical circuit associated with a second length of the wear measuring component, and
wherein determining the length of the wear measuring component comprises:
determining a first electrical resistance of the first closed loop electrical circuit;
determining that the first electrical resistance does not satisfy a resistance threshold; and
determining that the length of the wear measuring component is the second length based on determining that the first electrical resistance does not satisfy the resistance threshold.

13. The method of claim 12, wherein determining the length of the wear measuring component further comprises:
determining a second electrical resistance of the second closed loop electrical circuit;
determining that the second electrical resistance does not satisfy the resistance threshold; and
determining that the length of the wear measuring component is a third length based on determining that the second electrical resistance does not satisfy the resistance threshold, after determining that the length of the wear measuring component is the second length,
wherein the first length exceeds the second length and the third length, and
wherein the second length exceeds the third length.

14. The method of claim 9, wherein the sensor device is a battery powered transmitter that is configured to transmit signals wirelessly, and
wherein providing the sensor data comprises:
wirelessly transmitting the sensor data to the controller.

15. A machine comprising:
a track assembly that includes a component having a first cavity and a second cavity extending from the first cavity to an outer surface of the component; and
a sensor device configured to be provided in the first cavity of the component, the sensor device being configured to:
determine an electrical property of a wear measuring component of the sensor device,
the wear measuring component extending from the first cavity through the second cavity to the outer surface;
determine a length of the wear measuring component based on the electrical property, and
generate sensor data indicating an amount of wear of the outer surface based on the length of the wear measuring component; and
a controller configured to provide a notification based on the amount of wear of the outer surface indicated by the sensor data.

16. The machine of claim 15, wherein the component is a track link pin,
wherein the track link pin is provided in a cavity of a track link bushing,
wherein the first cavity is parallel to a longitudinal axis of the track link pin, and
wherein the second cavity is provided at an angle with respect to the first cavity.

17. The machine of claim 15, wherein the sensor device is a battery powered transmitter that is configured to transmit signals wirelessly, and
wherein, to provide the sensor data, the sensor device is configured to:
wirelessly transmit the sensor data to the controller.

18. The machine of claim 15, wherein, to provide the notification, the controller is configured to:
determine whether the amount of wear of the outer surface satisfies a wear threshold; and
provide the notification based on determining that the amount of wear of the outer surface does not satisfy the wear threshold.

19. The machine of claim 15, wherein, to determine the electrical property, the sensor device is configured to:
determine an electrical resistance of the wear measuring component.

20. The machine of claim 19, wherein, to determine the length of the wear measuring component, the sensor device is configured to:
determine the length of the wear measuring component based on the electrical resistance.
